(19) United States
(12) Patent Application Publication
(10) Pub. No.: US 2023/0195984 A1
(43) Pub. Date: Jun. 22, 2023

(54) METHOD FOR TIMING SIGNOFF IN MIXED-TRANSISTOR DESIGNS

(71) Applicant: TEXAS INSTRUMENTS INCORPORATED, Dallas, TX (US)

(72) Inventors: Ajoy MANDAL, Bengaluru (IN); Venkatraman RAMAKRISHNAN, Bengaluru (IN); Steven BARTLING, Dallas, TX (US)

(21) Appl. No.: 17/559,442

(22) Filed: Dec. 22, 2021

(51) Int. Cl. G06F 30/3312

(52) U.S. Cl. CPC G06F 30/3312; G06F 2119/12

(57) ABSTRACT

A method for timing analysis includes receiving a physical design of an electric circuit, selecting a timing path within the electric circuit, and determining that the selected timing path includes a first logic cell implemented with a first type of transistor and a second logic cell implemented with a second type of transistor. The method further includes running a set of process corners with the first type of transistor at a given corner and the second type of transistor at a condition other than the given corner. The first type of transistor has a delay that is based on process correlation with the second type of transistor. The method also includes determining whether a timing requirement is met or not met for the selected timing path, and then reporting whether the timing requirement is met or not met.

### BACKGROUND

High-performance integrated circuits (ICs) may be characterized by, for example, the clock frequency(ies) at which they operate. Measuring the ability of a circuit to operate at the specified speed requires an ability to measure, during the design process, the minimum and maximum delay at numerous steps within the overall circuit. Moreover, delay calculation must be incorporated into the inner loop of timing optimizers at various phases of design, such as logic synthesis, layout (placement and routing), and in in-place optimizations performed late in the design cycle. While such timing measurements can theoretically be performed using a rigorous circuit simulation, such an approach is liable to be too slow to be practical. Static timing analysis (STA) facilitates the fast and reasonably accurate measurement of circuit timing. The speedup in timing analysis using STA comes from the use of simplified timing models and by mostly ignoring logical interactions in circuits. This has become a mainstay of design over the last few decades.

### SUMMARY

In at least one example, a method for timing analysis includes receiving a physical design of an electric circuit, selecting a timing path within the electric circuit, and determining that the selected timing path includes a first logic cell implemented with a first type of transistor and a second logic cell implemented with a second type of transistor. The method further includes running a set of process corners with the first type of transistor at a given corner and the second type of transistor at a condition other than the given corner. The first type of transistor has a delay that is based on process correlation with the second type of transistor. The method also includes determining whether a timing requirement is met or not met for the selected timing path, and then reporting whether the timing requirement is met or not met. A non-transitory storage device containing software the causes a computer system to perform the above illustrated method is also described herein, as well as a processor that that executes software to perform the method.

### BRIEF DESCRIPTION OF THE DRAWINGS

For a detailed description of various examples, reference will now be made to the accompanying drawings in which:

FIG. 1 is an example of timing path of an electric circuit.

FIG. 2 shows timing scenarios in accordance with an example.

FIG. 3 is a flowchart of a method for timing analysis in accordance with an example.

FIG. 4 is a block diagram of a computer system for performing timing analysis in accordance with an example.

The same reference number is used in the drawings for the same or similar (either by function and/or structure) features.

### DETAILED DESCRIPTION

In a synchronous digital system, data is supposed to move in lockstep, advancing one stage on each tick (rising or falling edge) of the clock signal. This is enforced by synchronizing elements such as flip-flops or latches, which copy their input to their output upon receipt of a clock edge. A variety of timing errors are possible in such a system. A maximum time violation means that a signal (e.g., a signal to the data input of a flip-flop) arrives too late and misses the time when it should advance. This type of timing violation is also referred to as a “setup” error. A minimum time violation means that an input signal changes too soon after the clock's active transition. This type of timing violation is referred to as a “hold” error.

The time when a signal arrives to, for example, a flip-flop can vary due to reasons such as process, voltage, and temperature. Temperature can affect the electrical characteristics of passive and active components. Such electrical characteristics can also be affected by the magnitude of the supply voltage. For example, a transistor may turn on faster at larger gate-to-source voltages (which may occur at higher supply voltages). Process refers to manufacturing variations when fabricating the ICs. For example, the threshold voltage of a given transistor on an IC may be designed for a specific nominal value, but the actual threshold voltage for that transistor may vary between ICs. The goal of STA is to verify that despite these possible variations, all signals will arrive neither too early nor too late to a given point in the circuit (e.g., a flip-flop), and hence proper circuit operation can be assured.

Different types of transistors can be fabricated on an IC to take advantage of their respective characteristics. Transistor type refers to the type and/or thickness of the gate oxide, the types and concentrations of implants used to form the transistor, etc. Transistors of the same type tend to be correlated in that for a given mix of process, voltage, and temperature, the characteristics of the transistors (e.g., threshold voltage, on-resistance, etc.) are correlated. Transistors of different types generally are not correlated.

Designing circuits with a mix of different types of transistors can take advantage of their respective characteristics. However, because of the lack of correlation between different transistor types, timing critical circuits within an IC tend to use only transistors of one type. Generally, the worst-case timing problem for a circuit that only uses transistors of one type occurs at a slow corner for the IC at which the propagation delay through the circuit is at its largest value or at the fast corner for the IC at which the propagation delay through the circuit is at its smallest value.

Transistor types sharing low correlation have conventionally been used in IC design in a manner in which circuit cells (e.g., logic gates, flip-flops, application-specific circuits, etc.) implemented with transistors of one type avoid timing interactions with circuit cells implemented with transistors of another type. This approach avoids the complexity of timing closure with respect to process spreads by avoiding timing interactions. However, with increasing demands of timing, power, and test complexity tradeoffs, it is becoming desirable to design ICs that have circuits that involve timing interactions between domains of dissimilar transistor types. The disclosed embodiments are directed to timing analysis and closure of such mixed-transistor type designs.

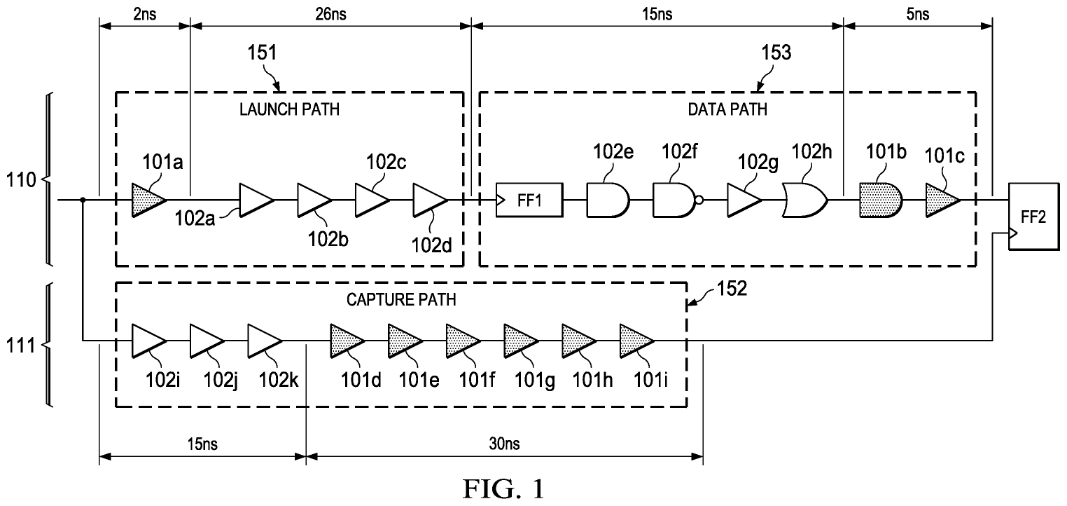

The timing complication introduced by the use of mixed transistor types is illustrated in FIG. 1. FIG. 1 is a block diagram of a portion of the circuitry on an IC. The block diagram includes various cells and two flip-flops FF1 and FF2. The cells include cells 101a-101i (collectively, cells 101) and 102a-102k (collectively, cells 102). Each cell includes one or more transistors and possibly other components configured to perform a given function. Examples of such functions include logic gates such as AND gate, OR gates, inverters, and the like. A cell can also be a non-standard circuit specifically designed to perform a custom function. Cells 101 are shaded and cells 102 are not shaded. Cells 101 are fabricated with a different type of transistor than cells 102, and the shading/no shading helps to visualize cells of different transistor types. Some cells are shown symbolically as triangles but that is not intended to imply a logical buffer or inverter, although it could be a buffer or an inverter. Each cell is shown with one input, but in general has one or more inputs.

Each cell is characterized by a nominal propagation delay. As explained below, the actual delay of a cell may vary from its nominal value due to process variations (as well as supply voltage and temperature variations). FIG. 1 illustrates launch, capture, and data paths 151, 152, and 153, respectively. The launch path 151 includes cells 101a and 102a-102d. The capture path 152 includes cells 102i-102k and 101d-101i. The data path 153 includes flip-flop FF1, cells 102e-102h, cell 101b, and cell 101c. FIG. 1 provides various propagation delay values which are the delay values for the cells at a slow corner. The delay values of the cells in the launch path 151 is the sum of the delays of cells 101a, 102a, 102b, 102c, and 102. FIG. 1 illustrates an example in which the delay of cell 101a at a slow corner is 2 ns and the combined slow corner delay of cells 102a-102d is 26 ns. Accordingly, the launch path delay is 28 ns. The combined delay of the capture path 152 is 15 ns plus 30 ns, which 45 ns. Similarly, the combined delay of the data path 153 is 15 ns plus 5 ns, which 20 ns.

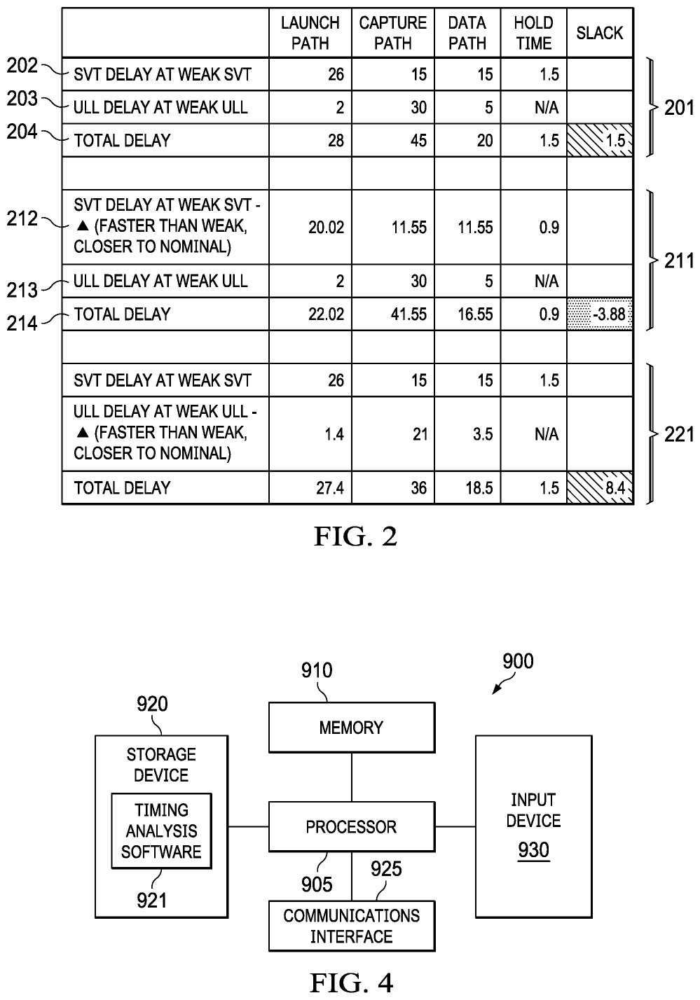

To meet the setup and hold timing requirements of flip-flop FF2, the data signal must be present on the data input of flip-flip FF2 by at least the setup time period of the flip-flop before a clock edge arrives, and must remain steady on the data input for at least the hold time after the clock edge arrives. FIG. 2 includes a table showing three timing scenarios 20-203 for the circuit of FIG. 1.

Timing scenario 201 includes delay values of the cells 101 and 102 at their slow corners. Timing scenario 201 has rows 202-204. Row 202 includes the slow corner delays of cells 102 of the first type (e.g., SVT), and row 203 includes the slow corner delays of cells 101 of the second type (e.g., ULL). Row 204 includes the total slow corner delay of all of the cells 101 and 102 within the launch, capture, and data paths. The total delay of the cells in the launch path 151 for both cell types' transistors being at their slow corners is 28 ns. Similarly, the total delay of the cells in the capture path 152 for both cell types' transistors being at their slow corners is 45 ns. The total delay of the cells in the data path 153 for both cell types' transistors being at their slow corners is 20 ns. In this example, flip-flop FF2 has a hold time of 1.5 ns, which means that the signal on the data input of flip-flop FF2 must remain valid for at least 1.5 ns after an active edge is asserted on the clock input of the flip-flop. The slack time in timing scenario 201 represents the amount of “extra” time above and beyond the minimum necessary to just meet the hold time. The slack time is the launch time plus the data time minus the capture time and mins the hold time of the flip-flop. Based on the slow corner values in timing scenario, the slack time is 1.5 ns. This means that, even with all of the transistors of cells 101 and 102 at their slow corners, the data signal will remain valid on the data input of flip-flop FF2 for another 1.5 ns after the minimum hold time necessary for the flip-flop. That the slack time in timing scenario is a positive value means that the hold time of flip-flop FF2 is ensured even with the cells 101 and 102 transistors all at their slow corners.

As described above, different types of transistors may not be very correlated. Two transistors that are relatively uncorrelated may result in one type of transistor being at its slow corner while the other type of transistor is faster than it would otherwise be if at its slow corner. Similarly, uncorrelated transistors may result in one type of transistor being at its fast corner while the other type of transistor is slower than it would otherwise be if at its fast corner. That is, a mix of transistor types does not necessarily result in all of the transistors of an IC being similarly at slow or fast corners (or somewhere in between).

Timing scenario 211 is an example in which the transistors of cells 101 are at a slow corner but the transistors of cells 102 are faster than their slow corner. The propagation delays for cells 101 (row 213) are thus the slow corner delays of FIG. 1 and as is shown in row 203. The propagation delays of the cells 102 in the launch, capture, and data paths in row 212 as well as the hold time of flip-flop FF2 are smaller than was the case for row 202. The resulting slack time is calculated in this example to be −3.88 ns. Because this slack time is a negative number, flip-flop FF2 may experience a hold time violation when cells 101 are at a slow corner, but cells 102 are between their slow corner and nominal values.

Timing scenario 221 is similar to timing scenario 211 but for the case in which the transistors of cells 102 are at their slow corner but the transistors of cells 101 have delays that are faster than their slow corner. The resulting slack time is calculated in this third example as a positive 8.4 ns meaning that flip-flop FF2 will not experience a hold time violation in this situation.

The timing scenario 201 illustrates the point that hold time violations may not be identified if all cells in a design are assumed to be at their slow corner. Instead, hold time violations (or setup time violations) may be identified if the cells having a first type of transistor is at a slow corner but other cells that are part of the same timing path are faster than their slow corners, or if the cells having a first type of transistor is at a fast corner but other cells that are part of the same timing path are slower than their fast corner.

A simplified delay model of a logic cell models the delay of the cell as a function of a nominal delay value as well as one or more global variations and a local variation. The embodiments described herein extend that delay model to also include cross-terms between global and local variation variables. In one example, the delay model is:

D=Dnom=P₁*V₁+P₂*V₂+. . . Pₙ*Vₙ+Pₘₘ*Vₘₘ+L₁*V₁*Vₘₘ+L₂*V₂*Vₘₘ+. . . Lₙ*Vₙ*Vₘₘ (1)

where D is modeled delay of the cell, Dₙₒₘ is the nominal delay value, P₁, P₂, . . . , Pn are coefficients of global variation, Pₘₘ is the coefficient of local variation, V₁, V₂, . . . , Vₙ are the random variables used for modeling global process variation, Vₘₘ is the random variable used for modeling local variation, and L₁, L₂, . . . , Lₙ are the coefficients of cross-terms between the global variation variables and local variation variables. The terms L₁*V₁*Vₘₘ+L₂*V₂*Vₘₘ+ . . . Lₙ*Vₙ*Vₘₘ to the delay model of Eq. (1) helps to model the local variation impact which in turn depends on the global process corner.

Any given timing path (e.g., the timing path of FIG. 1) in an IC design may have a mix of transistor types (such as the timing path of FIG. 1) or may be comprised of cells having predominantly only one type of transistor. To perform timing analysis of the former timing path (mixed types of transistors), the delay model (1) above is used. For the timing analysis of the latter timing path (predominantly one type of transistor), the delay model (2) below is used:

D=Dₙₒₘ=P₁*V₁+P₂*V₂+. . . Pn*Vₙ+Pₘₘ*Vₘₘ (2)

The model of equation (2) does not include the cross-terms of equation (1).

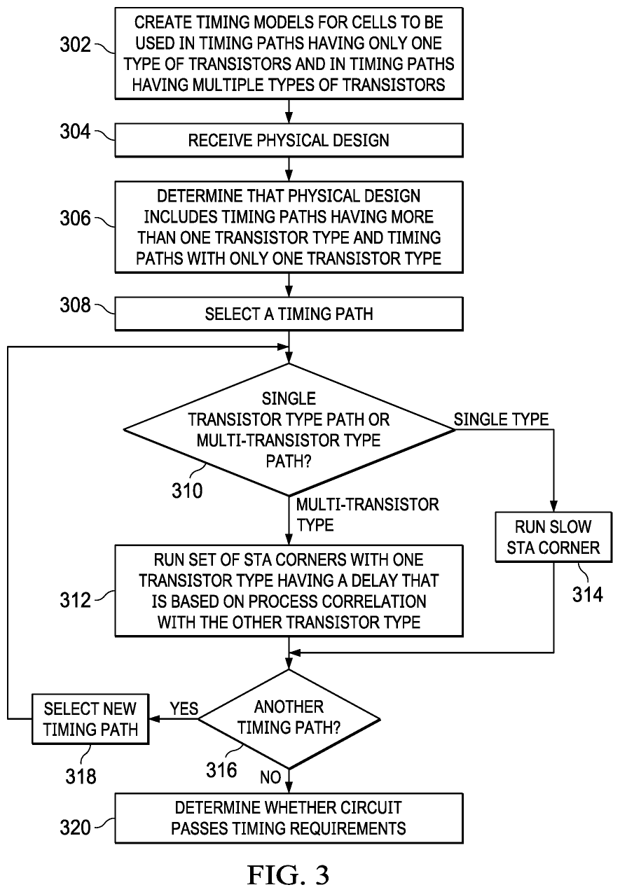

FIG. 3 is a flowchart of a method for performing timing closure in accordance with an example. At 302, the method includes creating timing models for logic cells to be used in timing paths. The timing paths include paths having only one type of transistors for its logic cells and paths having multiple types (and thus uncorrelated) of transistors.

Steps 304-318 may be implemented in software and executed on a computer. At 304, the method includes the receipt of a physical design by the software. The physical design may be the electrical circuit schematic (or digital representation of the circuit) for an entire IC, or a portion of the IC's circuitry. The physical design includes representations of logic cells and their interconnection. The physical design may be, for example, one or more files and opened into the timing analysis software.

At 306, the timing analysis software determines that the physical design includes timing paths having more than one transistor type and timing paths with only one transistor type. This operation may be performed by the timing analysis software parsing the physical design file(s) to identify the various timing paths.

At 308, one of the timing paths is selected by the timing analysis software for timing closure analysis. At 310, the timing analysis software determines whether the selected path is a single transistor type timing path or a multi-transistor type timing path. If the selected timing path has multiple types of transistors, then at 312 the software runs a set of static timing analysis (STA) corners with one transistor type that has a delay that is based on process correlation with the other transistor type. The timing delay model of Eq. (1) is used for this purpose by the timing analysis software. Accordingly, the delays of the logic cells within the selected timing path are determined using the timing delay model of Eq. (1). The delay model of Eq. (1) includes the cross-terms between the global variation variables and local variation variables. The set of STA corners include (a) a first transistor type being modeled at its slow corner while a second transistor type is faster than its slow corner, and (b) the second transistor type being modeled at its slow corner while the first transistor type is faster than its slow corner. Similarly, a set of STA corners could include (a) a first transistor type being modeled at its fast corner while a second transistor type is slower than its fast corner, and (b) the second transistor type being modeled at its fast corner while the first transistor type is slower than its fast corner. For each slow/slightly faster combination of corners, the timing analysis software calculates and stores slack values for the setup and hold times of the timing path.

However, if the timing path selected at 308 has only a single transistor type, then at 314, the timing analysis software runs (e.g., analyzes) a given STA corner (slow or fast) using the delay model of Eq. (2) above to model the delay of the cells of the selected timing path. The delay model of Eq. (2) does not include the cross-terms between the global variation variables and local variation variables. The timing analysis software calculates and stores slack values for the setup and hold times of the selected timing path with the cells of the selected timing path modeled at their slow or fast corner.

The timing analysis software determines at 316 whether a timing path in the physical design remains to be analyzed. If a timing path remains for analysis, then a new timing path is selected at 318 by the software, and control loops back to step 310 and the process repeats with the newly selected timing path.

Once all relevant timing paths have been analyzed by the timing analysis software, then at 320, the timing analysis software determines whether the physical circuit passes the timing requirements. This step may be performed, for example, by the timing analysis determining whether any of the timing paths that were analyzed had any setup or hold timing violations. If none of the timing paths had any timing violations, the timing analysis software reports a “passing” result; otherwise, the timing analysis software identifies the timing path(s) that had a setup or hold timing violation. The report by the timing analysis software may be in the form of a generated file, a displayed result on a computer monitor, or any other suitable type of feedback.

FIG. 4 is an example implementation of a computer system 900 on which the timing analysis software may execute. System 900 includes a processing element such as processor 905. Processor 905 may be implemented as multiple processors in some embodiments. Each processor 905 may include a single processor core or multiple processor cores. Examples of processors include, but are not limited to, a central processing unit (CPU) or a microprocessor. Although not illustrated in FIG. 9, the processing elements that comprise processor 905 may also include one or more other types of hardware processing components, such as graphics processing units (GPUs), application specific integrated circuits (ASICs), field-programmable gate arrays (FPGAs), and/or digital signal processors (DSPs). In certain cases, processor 905 may be configured to perform the timing analysis tasks described above.

FIG. 4 includes memory 910 may be operatively and communicatively coupled to processor 905. Memory 910 may be a non-transitory storage device configured to store various types of data. For example, memory 910 may include one or more volatile devices such as random access memory (RAM). Non-volatile storage devices 920 can include one or more disk drives, optical drives, solid-state drives (SSDs), tape drives, flash memory, electrically programmable read only memory (EEPROM), and/or any other type non-transitory storage device designed to maintain data and/or software for a period of time after a power loss or a shut-down operation. The non-volatile storage devices 920 may be used to store programs that are loaded into the RAM when such programs executed by processor 905. In one embodiment, the storage device 920 stores the timing analysis software 921 described herein. The timing analysis software 921 is loaded into or otherwise executed by the processor 905 to perform the timing analysis described herein.

Software programs may be developed, encoded, and compiled in a variety of computing languages for a variety of software platforms and/or operating systems and subsequently loaded and executed by processor 905. In one embodiment, the compiling process of the software program may transform program code written in a programming language to another computer language such that the processor 905 is able to execute the programming code. For example, the compiling process of the software program may generate an executable program that provides encoded instructions (e.g., machine code instructions) for processor 905 to accomplish specific, non-generic, particular computing functions.

After the compiling process, the encoded instructions may then be loaded as computer executable instructions or process steps to processor 905 from storage 920, from memory 910, and/or embedded within processor 905 (e.g., via a cache or on-board ROM). Processor 905 may be configured to execute the stored instructions or process steps in order to perform instructions or process steps to transform the computing device into a non-generic, particular, specially programmed machine or apparatus. Stored data, e.g., data stored by a storage device 920, may be accessed by processor 905 during the execution of computer executable instructions or process steps to instruct one or more components within the computing device 900. Storage 920 may be partitioned or split into multiple sections that may be accessed by different software programs. For example, storage 920 may include a section designated for specific purposes, such as storing program instructions or data for updating software of the computing device 900. In one embodiment, the software to be updated includes the ROM, or firmware, of the computing device. In certain cases, the computing device 900 may include multiple operating systems. For example, the computing device 900 may include a general-purpose operating system which is utilized for normal operations. The computing device 900 may also include another operating system, such as a bootloader, for performing specific tasks, such as upgrading and recovering the general-purpose operating system, and allowing access to the computing device 900 at a level generally not available through the general-purpose operating system. Both the general-purpose operating system and another operating system may have access to the section of storage 920 designated for specific purposes.

The system 900 also includes a communications interfaces 925 may comprise one or more network interfaces (e.g., Ethernet). The physical design to be analyzed by the timing analysis software 921 may be transmitted to the system 900 via the communications interface 925, for example, by way of a local or broadband network. In some cases, the system 900 is a server computer, personal computer, or any other type of general computing device that is configured to perform the specific actions described herein. The system 900 may also include one or more input and/or output devices, not shown, examples of which include pointers (e.g., mouse), keyboard, monitor (e.g., touchscreen), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Modifications are possible in the described embodiments, and other embodiments are possible, within the scope of the claims.

What is claimed is:

1. A method for timing analysis, comprising:
receiving a physical design of an electric circuit;
selecting a timing path within the electric circuit;
determining that the selected timing path includes a first logic cell implemented with a first type of transistor and a second logic cell implemented with a second type of transistor;
running a set of process corners with the first type of transistor at a given corner and the second type of transistor at a condition other than the given corner, the first type of transistor having a delay that is based on process correlation with the second type of transistor;
determining whether a timing requirement is met or not met for the selected timing path; and
reporting whether the timing requirement is met or not met.

2. The method of claim 1, in which the first type of transistor differs from the second type of transistor in at least one of type of a gate oxide; thickness of the gate oxide, type of implants used to form the transistors, and concentrations of the implants used to form the transistors.

3. The method of claim 1, in which running the set of process corners includes determining the delay of the first type of transistor by, at least in part, computing a product of a first variable for modeling global process variation and a second variable for modeling local variation.

4. The method of claim 1, in which running the set of process corners includes determining the delay of the first type of transistor by, at least in part, computing a product of a coefficient, a first variable for modeling global process variation, and a second variable for modeling local variation.

5. The method of claim 1, in which running the set of process corners includes determining the delay of the first type of transistor by computing, at least in part;
a first product of a first coefficient, a first variable for modeling global process variation, and a second variable for modeling local variation;
a second product of a second coefficient and the first variable for modeling global process variation; and
a sum of the first product, the second product, and a nominal delay value for the first type of transistor.

6. A non-transitory storage device containing software that, when executed by a computer system, causes the computer system to:
receive a physical design of an electric circuit;
select a timing path within the electric circuit;
determine that the selected timing path includes a first logic cell implemented with a first type of transistor and a second logic cell implemented with a second type of transistor;
analyze delays of a first type of transistor at a slow corner and the second type of transistor faster than its respective slow corner, the first type of transistor having a delay that is based on process correlation with the second type of transistor;
analyze delays of the first type of transistor at its respective fast corner and the second type of transistor slower than its respective fast corner;
determine whether a timing requirement is met or not met for the selected timing path; and
report whether the timing requirement is met or not met.

7. The non-transitory storage device of claim 6, in which the first type of transistor differs from the second type of transistor in at least one of type of a gate oxide, thickness of the gate oxide, type of implants used to form the transistors, and concentrations of the implants used to form the transistors.

8. The non-transitory storage device of claim 6, in which the software causing the computer system to analyze the delays includes the software causing the computer system to determine the delay of the first type of transistor by, at least in part, computing a product of a first variable for modeling global process variation and a second variable for modeling local variation.

9. The non-transitory storage device of claim 6, in which the software causing the computer system to analyze the delays includes the software causing the computer system to determine the delay of the first type of transistor by, at least in part, computing a product of a coefficient, a first variable for modeling global process variation, and a second variable for modeling local variation.

10. The non-transitory storage device of claim 6, in which the software causing the computer system to analyze the delays includes the software causing the computer system to determine the delay of the first type of transistor by computing, at least in part:
a first product of a first coefficient, a first variable for modeling global process variation, and a second variable for modeling local variation;
a second product of a second coefficient and the first variable for modeling global process variation; and
a sum of the first product, the second product, and a nominal delay value for the first type of transistor.

11. A computer system, comprising:
a storage device containing software; and
a processor coupled to the storage device, wherein, when executed by the processor, the software causes the processor to:
receive a physical design of an electric circuit;
select a timing path within the electric circuit;
determine that the selected timing path includes a first logic cell implemented with a first type of transistor and a second logic cell implemented with a second type of transistor;
run a set of process corners with the first type of transistor at a slow corner and the second type of transistor faster than a slow corner, the first type of transistor having a delay that is based on process correlation with the second type of transistor;
determine whether a timing requirement is met or not met for the selected timing path; and
report whether the timing requirement is met or not met.

12. The computer system of claim 11, in which the first type of transistor differs from the second type of transistor in at least one of type of a gate oxide, thickness of the gate oxide, type of implants used to form the transistors, and concentrations of the implants used to form the transistors.

13. The computer system of claim 11, in which, the processor is configured to determine the delay of the first type of transistor by, at least in part, computing a product of a first variable for modeling global process variation and a second variable for modeling local variation.

14. The computer system of claim 11, in which, the processor is configured to determine the delay of the first type of transistor by, at least in part, computing a product of a coefficient, a first variable for modeling global process variation, and a second variable for modeling local variation.

15. The computer system of claim 11, in which, the processor is configured to determine the delay of the first type of transistor by, at least in part, computing:
a first product of a first coefficient, a first variable for modeling global process variation, and a second variable for modeling local variation;
a second product of a second coefficient and the first variable for modeling global process variation; and
a sum of the first product, the second product, and a nominal delay value for the first type of transistor.
